(19) United States
(12) Patent Application Publication
(10) Pub. No.: US 2020/0041853 A1
(43) Pub. Date: Feb. 6, 2020

(54) DISPLAY DEVICE

(71) Applicant: SHARP KABUSHIKI KAISHA, Sakai City, Osaka (JP)

(72) Inventor: KAZUKI OHFUKU, Sakai City (JP)

(21) Appl. No.: 16/339,656

(22) PCT Filed: Oct. 5, 2017
(86) PCT No.: PCT/JP2017/036249

§ 371 Date: Apr. 4, 2019

(30) Foreign Application Priority Data
Oct. 11, 2016 (JP) 2016-199850

(51) Int. Cl. G02F 1/1362; F21V 8/00; G02F 1/1335

(52) U.S. Cl. CPC G02F 1/136209; G02B 6/0088; G02F 1/133621; G02F 1/133553; G02F 1/133524

(57) ABSTRACT

A display device includes a lighting device and a display panel. The lighting device includes a light source, a light guide plate, and a frame shaped reflection member. The light guide plate includes a light entering end surface and a light exiting plate surface. The frame shaped reflection member surrounds an outer peripheral end surface of the light guide plate and reflects light from the light source. The display panel includes pixel portions, each of which transmits the light from the lighting device. The pixel portions include outer pixel portions arranged in an outer area of a display surface of the display panel and inner pixel portions arranged in an inner area of the display surface inner than the outer pixel portions. The outer pixel portions have light transmittance lower than light transmittance of the inner pixel portions.

### TECHNICAL FIELD

The present invention relates to a display device.

### BACKGROUND ART

As an example of a conventional liquid crystal display device, a structure disclosed in the following Patent Document 1 has been known. The liquid crystal display device disclosed in Patent Document 1 includes a liquid crystal display panel, a backlight including a light source and an optical member and emitting light toward the liquid crystal display panel, and a chassis including four side parts, an upper side part, a lower side part, a left side part, and a right side part and holding the liquid crystal display panel and/or the backlight. At least one of the four side parts of the chassis is formed of a first material having a relatively low light reflectance and the remaining side parts are made of a second material having a relatively high light reflectance.

### RELATED ART DOCUMENT

### Patent Document

Patent Document 1: Japanese Unexamined Patent Application Publication No. 2014-81521

### Problem to be Solved by the Invention

In the liquid crystal display device disclosed in Patent Document 1 described above, since the chassis includes the side part formed of the first material having the relatively low light reflectance, luminance relating to the light emitted from the backlight is lowered as much as the side part absorbs the light, so that light utilization efficiency is not satisfactory. In manufacturing the chassis, since two-color molding is performed using the first material and the second material, there is also a problem that a manufacturing cost is increased.

### DISCLOSURE OF THE PRESENT INVENTION

The present invention has been accomplished based on the above circumstances, and it is an object to suppress occurrence of luminance unevenness while maintaining favorable light utilization efficiency.

### Means for Solving the Problem

A display device of the present invention includes a lighting device and a display panel that displays an image on a display surface using light from the lighting device. The lighting device includes: a light source; a light guide plate including a light entering end surface that includes at least a part of an outer peripheral end surface and through which light from the light source enters and an light exiting plate surface including one of plate surfaces and through which the light exits; and a frame shaped reflection member having a frame shape and surrounding the outer peripheral end surface of the light guide plate. The frame shaped reflection member reflects the light. The display panel includes pixel portions each of which transmits the light from the lighting device. The pixel portions include outer pixel portions arranged in an outer area of the display surface and inner pixel portions arranged in an inner area of the display surface inner than the outer pixel portion. The outer pixel portions have light transmittance lower than light transmittance of the inner pixel portions.

According to the display device, the light emitted from the light source and entering the light guide plate through the light entering end surface travel through the light guide plate and exits from the light exiting plate surface. The light is used for image display on the display surface of the display panel. Light rays traveling through the light guide plate may reach end surfaces of the outer peripheral end surface and exit therethrough. The light rays exit through the end surfaces are reflected by the frame shaped reflection member surrounding the outer peripheral end surface of the light guide plate and returned to the light guide plate through the end surfaces. Incident angles of reentering light rays on the end surfaces tend to be inconsistent and more likely to immediately exit through the light exiting plate surface. Therefore, a quantity of the exiting light may locally increase in an outer area of the light exiting plate surface.

The display panel that displays the image on the display surface using the light from the lighting device is configured that the light transmittance of the outer pixel portion in the pixel portions arranged in the outer area of the display surface is lower than the light transmittance of the inner pixel portion. Thus, even if the quantity of the exiting light from the light exiting plate surface of the light guide plate locally increases in the outer area, light transmission through the outer pixel portions is more suppressed in comparison to the inner pixel portions. Therefore, differences in quantity of the exiting light between the inner area and the outer area of the display surface of the display panel are reduced. Since occurrence of luminance unevenness is suppressed by the outer pixel portions of the display panel, light reflectance of the frame shaped reflection member included in the lighting device needs not to be partially lowered as in a conventional case, so that proper light utilization efficiency can be achieved. Since the frame shaped reflection member needs not to be manufactured by a two-color molding method as in the conventional case, a manufacturing cost can be reduced. The above “light transmittance” is a ratio obtained by dividing a quantity of transmitted light by a quantity of incident light.

As embodiments of the present invention, the following configurations are preferable.

(1) Each of the outer pixel portions may have an area smaller than an area of each of the inner pixel portion. According to the configuration, the light transmittance of each of the outer pixel portions having the smaller area is lower than light transmittance of each of the inner pixel portions having a larger area.

(2) The display panel may include a light shielding portion that partitions the pixel portions, and the light shielding portion may include sections that partition the outer pixel portions and sections that partition the inner pixel portions. The sections that partition the outer pixel portions are wider than the sections that partition the inner pixel portions. According to the configuration, a quantity of the light absorbed or reflected by the sections of the light shielding portion, which partition the outer pixel portions, is larger than a quantity of the light absorbed or reflected by the sections of the light shielding portion, which partition the inner pixel portions. Therefore, the light transmittance of the outer pixel portion is relatively low.

(3) Each of the outer pixel portions may have a light absorption rate higher than a light absorption rate of each of the inner pixel portions. According to the configuration, the light transmittance of each of the outer pixel portions having the higher light absorption rate is lower than light transmittance of each of the inner pixel portions having a relatively low light absorption rate.

(4) The display panel may include coloring portions included in the pixel portions and transmitting specific colors of light rays. The coloring portions include inner coloring portions included in the inner pixel portions and outer coloring portions included in the outer pixel portions. The outer coloring portions have coloring densities higher than coloring densities of the inner coloring portions. The coloring portions includes in the pixel portions absorb light rays to pass the specific colors of light rays. Since the outer coloring portion included in the outer pixel portion among the coloring portions have the coloring densities higher than the color densities of the inner coloring portions included in the inner pixel portions, the outer coloring portions absorb a larger quantity of the light rays. Therefore, the light transmittance of the outer pixel portion is relatively low.

(5) The outer pixel portions may be arranged at positions that are at different distances from the inner pixel portions and the light transmittance of the outer pixel portions gradually becomes higher as approaching the inner pixel portions. The quantity of the light emitted from the light exiting plate surface of the light guide plate tends to decrease as approaching the inner area from the outer area. Since the light transmittance of the outer pixel portions gradually increases as approaching the inner pixel portions, differences in quantity of the transmitted light is less likely to occur between the outer pixel portions closer to the inner pixel portions and the inner pixel portion in comparison to a configuration in which the light transmittance of the outer pixel portions is constant. According to the configuration, the luminance unevenness is less likely to occur.

(6) The frame shaped reflection member may have light reflectance greater than a sum of the light absorption rate and the light transmittance. According to the configuration, when the light that has exited from the end surface of the light guide plate hits the frame shaped reflection member, a quantity of the light reflected by the frame shaped reflection member is larger than a quantity of the light absorbed by the frame shaped reflection member or a quantity of the light transmitted through the frame shaped reflection member. The light reflected by the frame shaped reflection member is returned to the light guide plate through the end surface and exits from the light exiting plate surface. The light is effectively utilized for image display on the display panel. Proper light use efficiency can be achieved.

### Advantageous Effect of the Invention

According to the present invention, occurrence of luminance unevenness is suppressed while favorable light utilization efficiency is maintained.

### BRIEF DESCRIPTION OF THE DRAWINGS

FIG. 1 is an exploded perspective view of a liquid crystal display device according to a first embodiment of the present invention.

FIG. 2 is a schematic sectional view illustrating a sectional configuration in a display region of a liquid crystal panel.

FIG. 3 is a plan view schematically illustrating a wiring configuration in a display region of an array substrate constituting the liquid crystal panel.

FIG. 4 is a plan view schematically illustrating a configuration of inner pixel portions in a display region of a CF substrate constituting the liquid crystal panel.

FIG. 5 is a plan view of a backlight device constituting the liquid crystal display device.

FIG. 6 is a sectional view illustrating a sectional configuration obtained by cutting the liquid crystal display device along a short side direction.

FIG. 7 is a sectional view illustrating a sectional configuration obtained by cutting the liquid crystal display device along a long side direction.

FIG. 8 is a plan view schematically illustrating a configuration of outer pixel portions in the display region of the CF substrate constituting the liquid crystal panel

FIG. 9 is a view illustrating graphs of luminance distribution of emitted light from an X1 end or a Y1 end to an X2 end or a Y2 end on a light guide plate of the backlight device.

FIG. 10 is a view illustrating graphs of distribution of opening areas of the pixel portions from the X1 end or the Y1 end to the X2 end or the Y2 end in the liquid crystal panel.

FIG. 11 is a view illustrating graphs of the luminance distribution of the emitted light from the X1 end or the Y1 end to the X2 end or the Y2 end on the liquid crystal panel.

FIG. 12 is a plan view schematically illustrating a configuration of inner pixel portions in a display region of a CF substrate according to a second embodiment of the present invention.

FIG. 13 is a plan view schematically illustrating a configuration of outer pixel portions in the display region of the CF substrate.

FIG. 14 is a view illustrating graphs of distribution of opening areas of pixel portions from an X1 end or a Y1 end to an X2 end or a Y2 end in a liquid crystal panel.

FIG. 15 is a view illustrating graphs of distribution of coloring densities of color filters from the X1 end or the Y1 end to the X2 end or the Y2 end in the liquid crystal panel.

FIG. 16 is a view illustrating a graph of distribution of opening areas of pixel portions from an X1 end to an X2 end in a liquid crystal panel according to another embodiment (1) of the present invention.

FIG. 17 is a view illustrating a graph of distribution of opening areas of pixel portions from an X1 end to an X2 end in a liquid crystal panel according to still another embodiment (2) of the present invention.

FIG. 18 is a view illustrating a graph of distribution of opening areas of pixel portions from an X1 end to an X2 end in a liquid crystal panel according to still another embodiment (3) of the present invention.

FIG. 19 is a view illustrating a graph of distribution of coloring densities of color filters from an X1 end to an X2 end in a liquid crystal panel according to still another embodiment (4) of the present invention.

FIG. 20 is a view illustrating a graph of distribution of coloring densities of color filters from an X1 end to an X2 end in a liquid crystal panel according to still another embodiment (5) of the present invention.

FIG. 21 is a view illustrating a graph of distribution of coloring densities of color filters from an X1 end to an X2 end in a liquid crystal panel according to still another embodiment (6) of the present invention.

### MODE FOR CARRYING OUT THE INVENTION

### First Embodiment

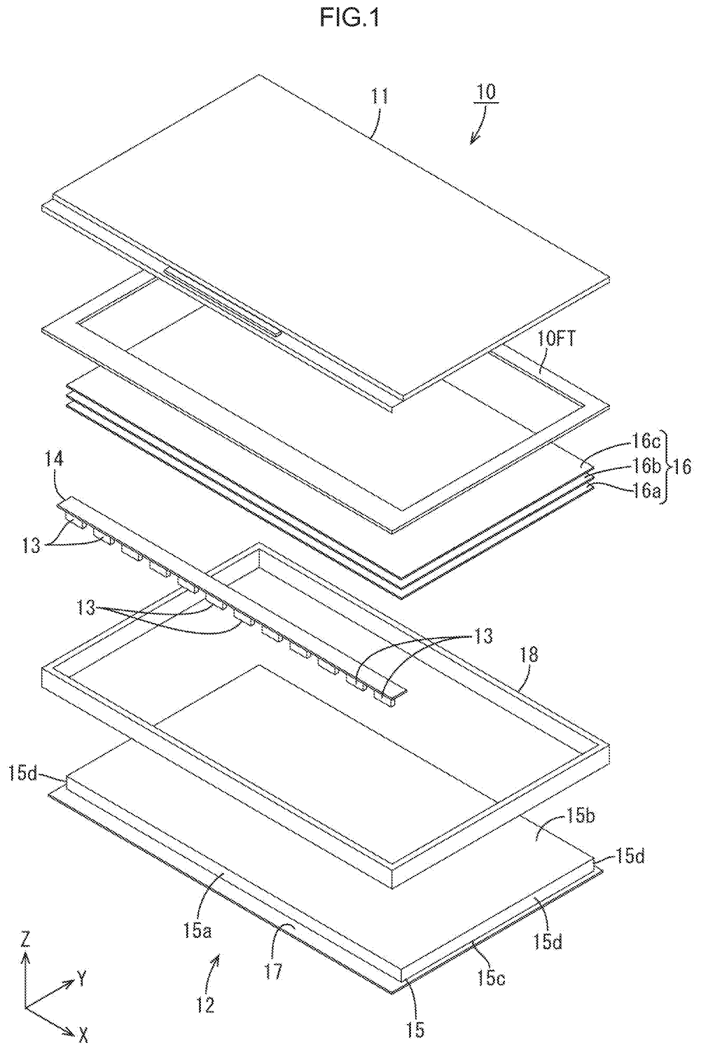

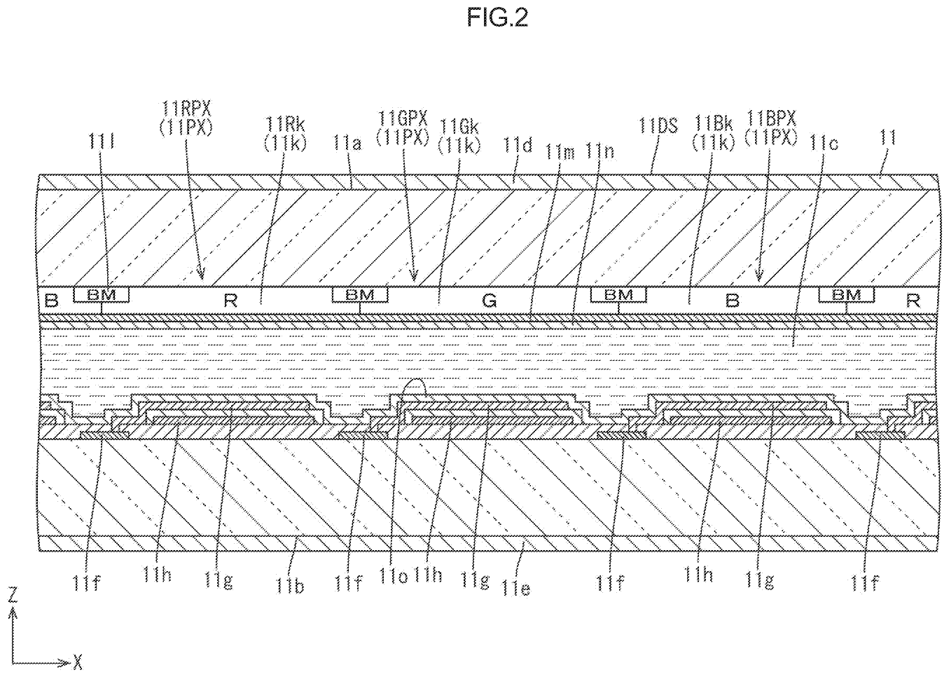

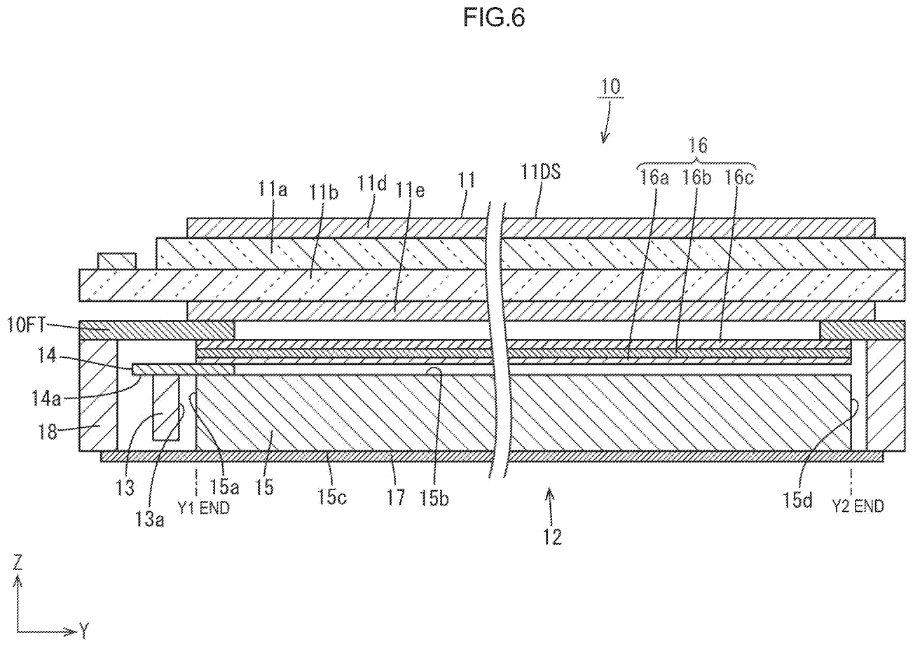

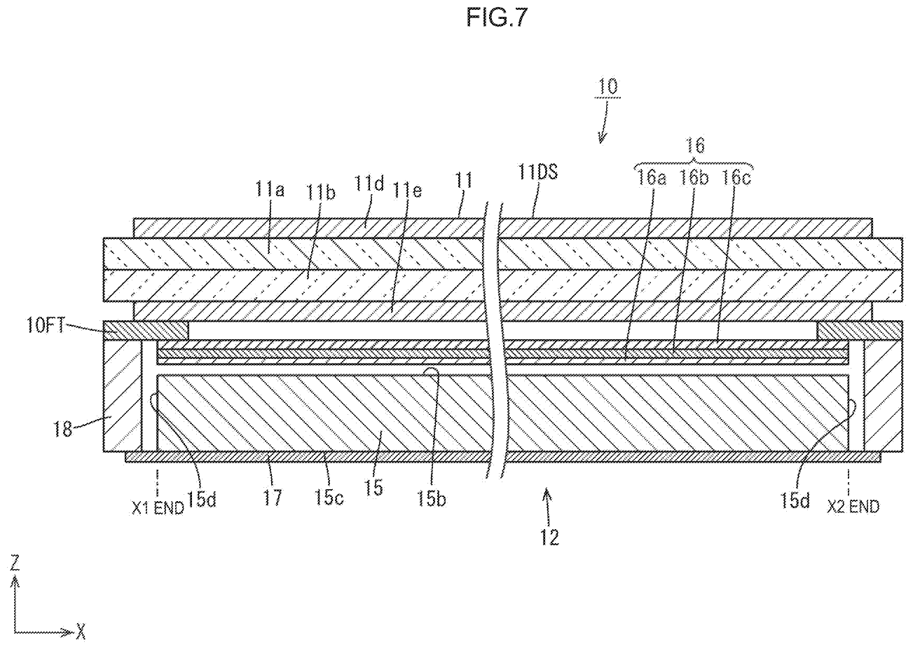

A first embodiment of the present invention will be described with reference to FIG. 1 to FIG. 11. In the present embodiment, a liquid crystal display device 10 will be exemplified. In a part of each drawing, an X axis, a Y axis, and a Z axis are shown, and each of axial directions is drawn in a direction shown in the respective drawings. Each of upper sides of FIG. 2, FIG. 6, FIG. 7 and the like is referred to as a front side, and each of lower sides thereof is referred to as a back side.

As shown in FIG. 1, the liquid crystal display device 10 has a horizontally elongated rectangular shape as a whole. The liquid crystal display device 10 includes a liquid crystal panel (display panel) 11 having a display surface 11DS configured to display an image, a backlight device (lighting device) 12 as an external light source disposed on the back side of the liquid crystal panel 11 to emit light for display on the liquid crystal panel 11, and a fixing tape 10FT for fixing the liquid crystal panel 11 and the backlight device 12. In the above configurations, the fixing tape 10FT is formed into a horizontally elongated frame shape following a frame shape of the liquid crystal display device 10 (non-display area of the liquid crystal panel 11). The fixing tape 10FT is preferably formed of, for example, a light shielding double sided tape in which adhesive materials are applied to both surfaces of a light shielding base material.

As shown in FIG. 1 and FIG. 2, the liquid crystal panel 11 has a horizontally elongated rectangular shape as a whole, and its long side direction corresponds to an X axis direction, its short side direction conforms to a Y axis direction, and its thickness direction conforms to a Z axis direction shown in each drawing. The liquid crystal panel 11 includes at least a pair of glass substrates 11a, 11b that are substantially transparent and have excellent translucency, and a liquid crystal layer 11c interposed between the both substrates 11a, 11b and containing liquid crystal molecules that is a material in which optical characteristics are changed corresponding to application of an electric field. The both substrates 11a, 11b are pasted with a sealant not shown in a state in which a gap corresponding to a thickness of the liquid crystal layer 11c is maintained. In the pair of substrates 11a, 11b constituting the liquid crystal panel 11, the front side (face side) is a color filter (CF) substrate (counter substrate) 11a and the back side (rear side) is an array substrate (active matrix substrate, TFT substrate) 11b. Each of the CF substrate 11a and the array substrate lib is formed by laminating various films on an inner surface side of the glass substrate. Polarizing plates 11d, 11e are respectively pasted to outer surface sides of the both substrates 11a, 11b. The liquid crystal panel 11 is divided into a display area disposed on an inner of a screen and on which the image is displayed and a non-display area (non-active area) disposed on an outer peripheral side of the screen and formed into a frame shape surrounding the display area (rim shape, annular shape) and on which the image is not displayed.

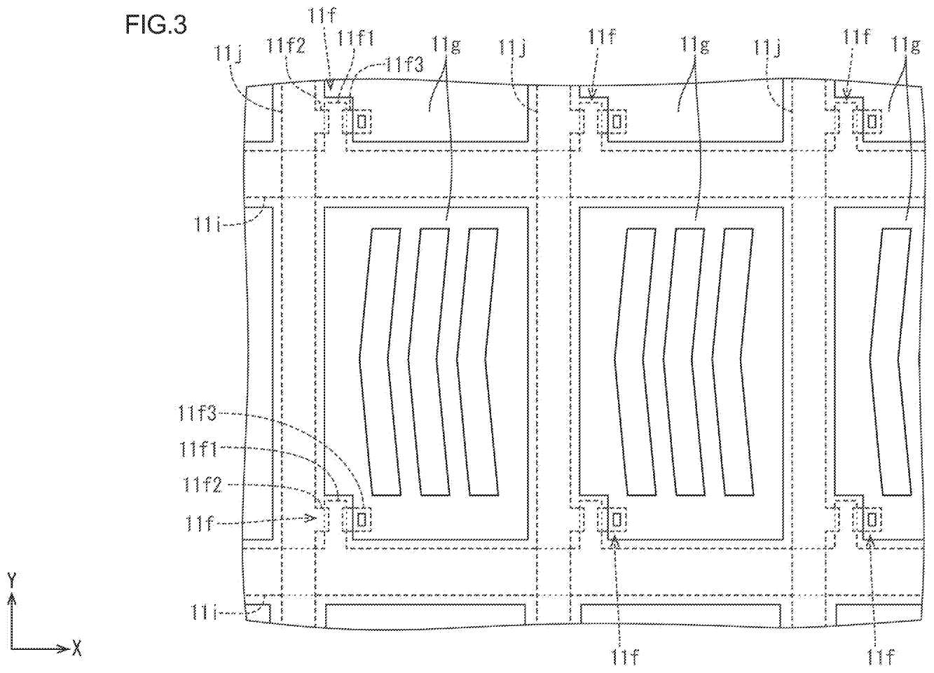

As shown in FIG. 2 and FIG. 3, a large number of thin film transistors (TFTs: display elements) 11f as switching elements and pixel electrodes 11g are provided in the display area on the inner surface side of the array substrate 11b (liquid crystal layer 11c side, an opposite surface side to the CF substrate 11a) so as to be arranged side by side in a matrix shape (matrix form). Around the TFTs 11f and the pixel electrodes 11g, lattice shape gate lines (scan lines) 11i and lattice shape source lines (data lines, signal lines) 11j are provided to surround them. Each of the gate lines 11i and each of the source lines 11j are respectively connected to gate electrodes 11f1 and source electrodes 11f2 of the TFTs 11f, and each of the pixel electrodes 11g is connected to a drain electrode 11f3 of the TFT 11f. Each of the TFTs 11f is driven based on various signals respectively supplied to the gate line 11i and the source line 11j, and supply of potential to the pixel electrode 11g is controlled in accordance with the driving. Each of the pixel electrodes 11g is arranged in a rectangular region surrounded by the gate lines 11i and the source lines 11j. On the inner surface side of the display area of the array substrate 11b, common electrodes 11h each of which is formed of a solid pattern superimposed on the pixel electrode 11g are formed at a lower layer side with respect to each of the pixel electrodes 11g. When a potential difference is generated between the pixel electrode 11g and the common electrode 11h that are superimposed on each other, a fringe electric field (oblique electric field) containing a normal direction component to a plate surface of the array substrate 11b in addition to a component along the plate surface of the array substrate 11b is applied to the liquid crystal layer 11c. In the liquid crystal panel 11 according to the present embodiment, an operation mode is a fringe field switching (FFS) mode. In each drawing of the present embodiment, an extending direction of each gate line 11i conforms to the X axis direction, and an extending direction of each source line 11j conforms to the Y axis direction.

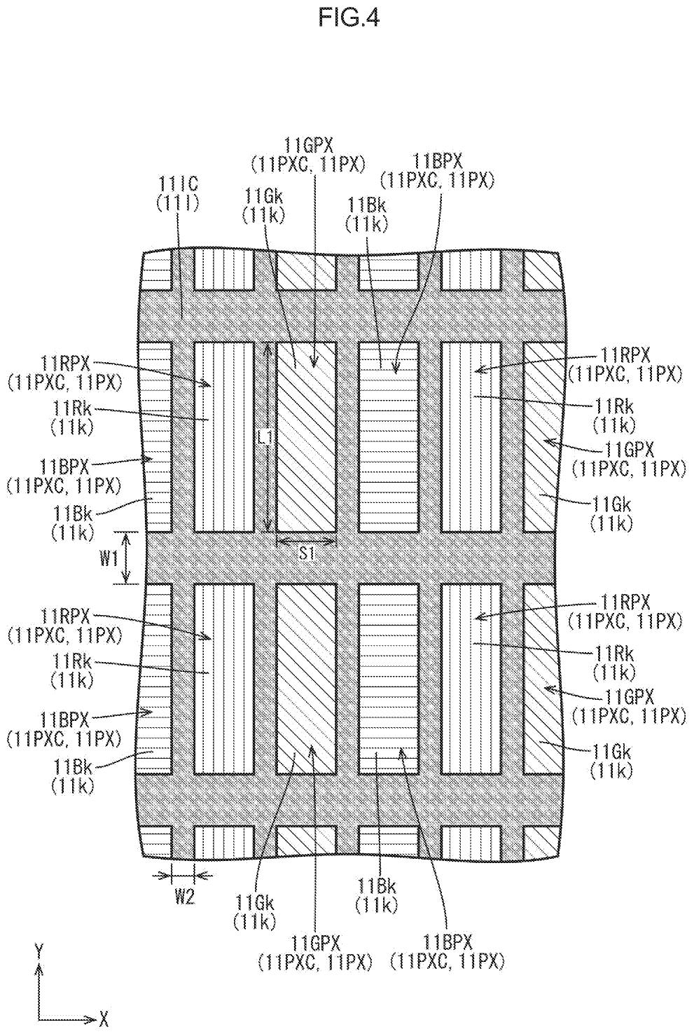

As shown in FIG. 2 and FIG. 4, a large number of color filters (coloring portions) 11k are provided side by side in a matrix shape at positions respectively opposite to the pixel electrodes 11g of the array substrate lib side in the display area on the inner surface side of the CF substrate 11a (liquid crystal layer 11c side, an opposite surface side to the array substrate 11b). The color filter 11k and the pixel electrode 11g opposite to each other constitute a pixel portion 11PX that transmits light from the backlight device 12. In the color filters 11k, three colors of a red color filter (red coloring portion) 11Rk exhibiting red color, a green color filter (green coloring portion) 11Gk exhibiting green color, and a blue color filter (blue coloring portion) 11Bk exhibiting blue color are repeatedly arranged side by side in a predetermined order along the X axis direction. Each of the color filters 11k contains a pigment corresponding to the color to be displayed, and selectively transmits colored light (light of a specific color) by absorbing non-colored light by the pigment. Specifically, the red color filter 11Rk that exhibits red color selectively transmits light of a red wavelength region (for example, from about 600 nm to about 780 nm), that is, red light, and constitutes a red pixel portion 11RPX together with the opposite pixel electrode 11g. The green color filter 11Gk that exhibits green color selectively transmits light of a green wavelength region (for example, from about 500 nm to about 570 nm), that is, green light, and constitutes a green pixel portion 11GPX together with the opposite pixel electrode 11g. The blue color filter 11Bk that exhibits blue color selectively transmits light of a blue wavelength region (for example, from about 420 nm to about 500 nm), that is, blue light, and constitutes a blue pixel portion 11BPX together with the opposite pixel electrode 11g. In the liquid crystal panel 11, a display pixel in which a color display of a predetermined gradation is performed is constituted by the pixel portions 11RPX, 11GPX, 11BPX of three colors of R, G, B adjacent to each other along the X axis direction. The pixel portions 11RPX, 11GPX, 11BPX of the three colors constituting the display pixel are repeatedly arranged side by side along the X axis direction (row direction) on the display surface 11DS of the liquid crystal panel 11, so that a display pixel group is constituted and a large number of display pixel groups are arranged side by side along the Y axis direction (column direction).

As shown in FIG. 2 and FIG. 4, in the CF substrate 11a, a light shielding portion (black matrix) 11l in a substantial lattice shape partitioning between the adjacent color filters 11k is formed. The light shielding portion 11l is made of a light shielding material having a black surface, and light absorption rate of the light shielding portion 11l is larger than a numerical value obtained by adding light reflectance and the light transmittance. Specifically, the light absorption rate of the light shielding portion 11l is preferably 90% or more, and the numerical value obtained by adding the light reflectance and the light transmittance is 10% or less. The light shielding portion 11l mainly exhibits a light shielding function by absorbing light as described above, and also exhibits the light shielding function by reflecting the light. The light shielding portion 11l partitions between the adjacent pixel portions 11PX. In the light shielding portion 11l, a portion (portion extending along the Y axis direction) partitioning between the pixel portions 11PX that exhibit the different colors is intended to prevent color mixing between the pixel portions 11PX and a portion (portion extending along the X axis direction) partitioning between the pixel portions 11PX that exhibit the same colors is intended to secure independence of the gradation of each of the pixel portions 11PX. The lattice-shaped light shielding portion 11l is disposed so as to be at least partly superimposed on the gate lines 11i and the source lines 11j described above when viewed from a plane. An overcoat film 11m is provided on surfaces of the color filters 11k and the light shielding portion 11l. On the surface of the overcoat film 11m, a photo spacer not shown is provided. As layers in innermost sides (near the liquid crystal layer 11c) of both substrates 11a, lib and in contact with the liquid crystal layer 11c, alignment films 11n, 11o for aligning the liquid crystal molecules contained in the liquid crystal layer 11c are formed.

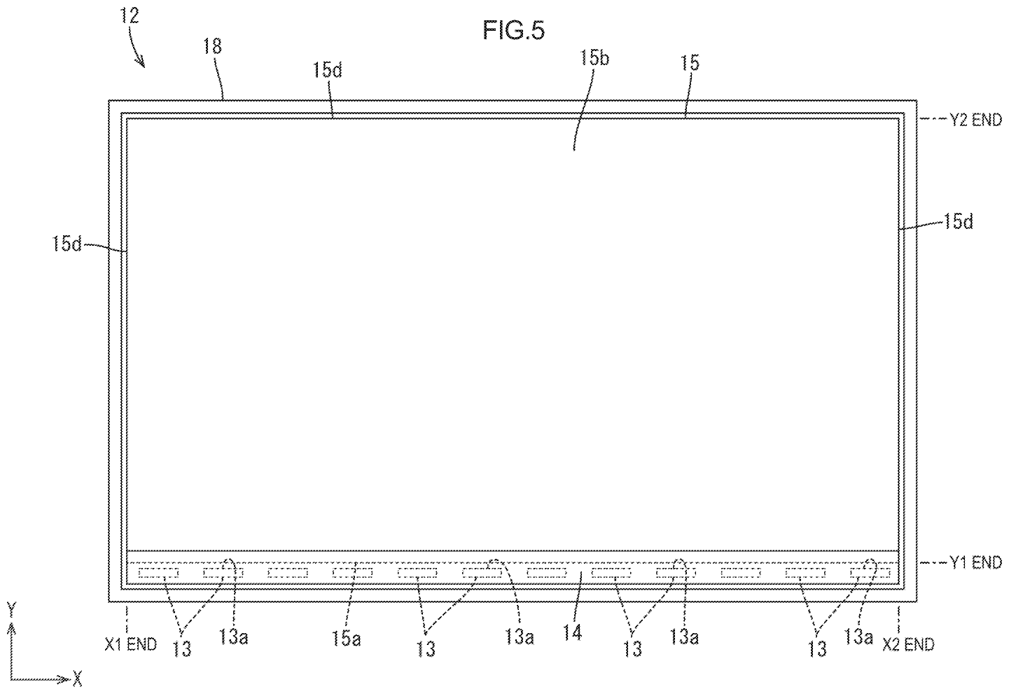

The backlight device 12 will be described hereinafter. As shown in FIG. 1 and FIG. 5, the backlight device 12 includes at least light emitting diodes (LEDs) 13 as a light source, an LED substrate (light source substrate) 14 on which the LEDs 13 are mounted, a light guide plate 15 introducing light from the LEDs 13, an optical sheet (optical member) 16 disposed to be layered on the front side of the light guide plate 15, a reflection sheet (reflection member) 17 disposed to be layered on the back side of the light guide plate 15, and a frame-shaped frame (a frame shaped reflection member) 18 surrounding the LEDs 13, the light guide plate 15, the optical sheet 16, and so on. In the backlight device 12, the LED substrate 14 is disposed at one end portion of a pair of end portions of long sides, and each of the LEDs 13 mounted on the LED substrate 14 is unevenly distributed near one end of the long sides of the liquid crystal panel 11. The backlight device 12 according to the present embodiment is set as an edge light type (side light type) of a one side light incident type in which the light of the LED 13 is incident on the light guide plate 15 only from one side. Each component of the backlight device 12 will be described in detail hereinbelow.

As shown in FIG. 1 and FIG. 6, each of the LEDs 13 has a configuration in which an LED chip is sealed with a sealing material on a substrate portion fixed to the LED substrate 14. In each LED 13, the LED chip emits, for example, the blue light in a single color, and a phosphor (yellow phosphor, a green phosphor, a red phosphor or the like) is dispersed in the sealing material to emit white light as a whole. Each of the LEDs 13 is set as a so-called side surface emission type in which a surface adjacent to another surface to be mounted on the LED substrate 14 is a light emitting surface 13a.

As shown in FIG. 1 and FIG. 6, the LED substrate 14 has a horizontally elongated rectangular shape (long side direction is made to conform to the X axis direction, and a short side direction is made to conform to the Y axis direction) as a whole. Plate surfaces of the LED substrate 14 are parallel to plate surfaces of the light guide plate 15 or the like, and the plate surface on the back side of the LED substrate 14 is a mounting surface 14a on which the LEDs 13 are mounted. On this mounting surface 14a, a wiring pattern (not shown) for supplying power to the LEDs 13 is patterned, and the LEDs 13 are mounted so as to be arranged in a manner spaced apart along the X axis direction. The LED substrate 14 is disposed on the front side with respect to the frame 18 and the light guide plate 15, and is disposed so as to be sandwiched between these and the liquid crystal panel 11.

The light guide plate 15 is made of a substantially transparent synthetic resin material (for example, an acrylic resin such as polymethyl methacrylate (PMMA) or polycarbonate) having a sufficiently higher refractive index than that of air, specifically about 1.49 in a case of the acrylic resin, and about 1.57 in a case of the polycarbonate. As shown in FIG. 1 and FIG. 5, the light guide plate 15 has a horizontally elongated plate shape like the liquid crystal panel 11. The light guide plate 15 is accommodated in a form surrounded by the frame 18 and disposed at a position immediately below the liquid crystal panel 11 and the optical sheet 16. Its long side direction conforms to the X axis direction, its short side direction conforms to the Y axis direction, and its thickness direction conforms to the Z axis direction of each drawing. As shown in FIG. 5 to FIG. 7, in the light guide plate 15, an end surface on one long side (left side in FIG. 6) of its outer peripheral end surface is a light entering end surface (an opposite end surface) 15a that is opposite to the LEDs 13 and on which the light from the LEDs 13 is incident, whereas the remaining three end surfaces (end surface on the other long side and end surfaces on a pair of short sides) are non-light entering end surfaces (a non-opposite end surfaces) 15d each of which is not opposite to the LEDs 13 and on which the light from the LEDs 13 is not directly incident. The light entering end surface 15a is parallel to the light emitting surface 13a of each of the LEDs 13 and extends along the X axis direction (direction in which the LEDs 13 are arranged). In the light guide plate 15, a plate surface facing the front side (liquid crystal panel 11 side) of a pair of the front and back plate surfaces is a light exiting plate surface 15b for emitting light toward the liquid crystal panel 11, and a plate surface facing the back side is an emitting opposite plate surface 15c on a side opposite to the light exiting plate surface 15b. The light exiting plate surface 15b is parallel to a plate surface (display surface 11DS) of the liquid crystal panel 11, and opposite to the plate surface of the liquid crystal panel 11 to sandwich the optical sheet 16 to be described below. According to the above structure, the light guide plate 15 has function in which the light emitted along the Y axis direction from each of the LEDs 13 is introduced from the light entering end surface 15a and is propagated inside the light guide plate 15, and then rises along the Z axis direction to emit from the light exiting plate surface 15b toward the optical sheet 16 side (front side, emitting side).

As shown in FIGS. 1 and 6, like the liquid crystal panel 11 and the light guide plate 15, the optical sheet 16 has a horizontally elongated plate shape. The optical sheet 16 is disposed such that plate surfaces thereof are parallel to the plate surfaces of the liquid crystal panel 11 and the light guide plate 15 and the optical sheet 16 is interposed between the liquid crystal panel 11 and the light guide plate 15 in the Z axis direction. Thereby, the optical sheet 16 emits the light toward the liquid crystal panel 11 while giving a predetermined optical action to the light emitted from the light guide plate 15. Specifically, the optical sheet 16 according to the present embodiment includes three sheets, namely, a micro-lens sheet 16a that imparts an isotropic light condensing action to the light, a prism sheet 16b that imparts an anisotropic light condensing action to the light, and a reflective polarizing sheet 16c that polarizes and reflects the light. In the optical sheet 16, the micro-lens sheet 16a, the prism sheet 16b, and the reflective polarizing sheet 16c are laminated to each other in this order from the back side.

As shown in FIG. 1 and FIG. 6, the reflection sheet 17 is disposed such that plate surfaces thereof are parallel to the plate surfaces of the liquid crystal panel 11 and the light guide plate 15, and the reflection sheet 17 covers the emitting opposite plate surface 15c of the light guide plate 15. The reflection sheet 17 is excellent in light reflectivity and efficiently raises the light leaked from the emitting opposite plate surface 15c of the light guide plate 15 toward the front side (toward the light exiting plate surface 15b). The reflection sheet 17 has a slightly larger outer shape than that of the light guide plate 15 and is disposed such that an end portion on one long side of the reflection sheet 17 protrudes toward the LEDs 13 side from the light entering end surface 15a.

The frame 18 is made of a synthetic resin (for example, made of polycarbonate). A surface of the frame 18 exhibits white color and is excellent in light reflectivity like the reflection sheet 17, and light reflectance of the frame 18 is larger than a numerical value obtained by adding light absorption rate and light transmittance. Specifically, the light reflectance of the frame 18 is preferably 90% or more, and the numerical value obtained by adding the light absorption rate and the light transmittance is 10% or less. As shown in FIG. 5 to FIG. 7, the frame 18 is formed into a horizontally elongated frame shape having a slightly larger outer shape than that of the light guide plate 15, and the frame 18 is disposed to collectively surround the LEDs 13, the light guide plate 15, the optical sheet 16, and so on. Specifically, the frame 18 includes a pair of long side portions and a pair of short side portions, and a long side dimension and a short side dimension thereof are set to be larger than a long side dimension and a short side dimension of the light guide plate 15, respectively, and a dimension of a height (dimension in the Z axis direction) is set to be larger than a plate thickness dimension of the light guide plate 15. The pair of long side portions and the pair of short side portions constituting the frame 18 are made to have the same light reflectance each other and are resin molded using the same metal mold. An inner peripheral surface of the frame 18 is opposite to the outer peripheral end surface of the light guide plate 15. The frame 18 reflects the light leaked out from any part of the outer peripheral end surface of the light guide plate 15 (the light entering end surface 15a and the non-light entering end surfaces 15d) to allow the light to be incident on each of the end surfaces 15a, 15d again, so that light utilization efficiency is improved. One long side portion of the frame 18 opposite to the light entering end surface 15a of the light guide plate 15 is also opposed to an opposite surface to the light emitting surface 13a of each of the LEDs 13 and the end surface of the LED substrate 14. The inner peripheral surface of the frame 18 is also opposite to an outer peripheral end surface of each optical sheet 16. On a front side surface of the frame 18, the adhesive material on the back side of the fixing tape 10FT having light shielding property as described above is fixed, whereby the frame 18 is fixed to the liquid crystal panel 11 via the fixing tape 10FT.

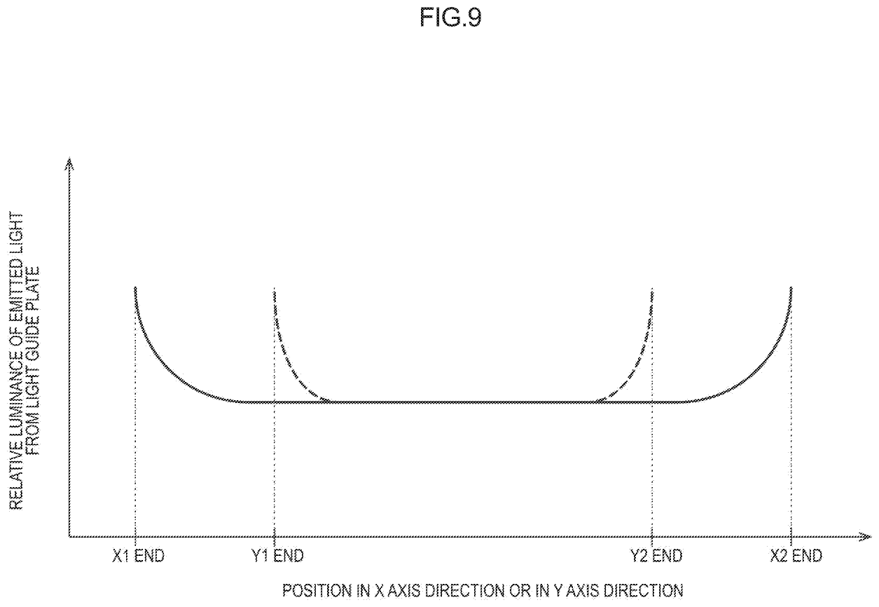

In the backlight device 12 having the configuration, as shown in FIG. 6, when the light emitted from each LED 13 is incident on the light entering end surface 15a of the light guide plate 15, the light is emitted from the light exiting plate surface 15b after propagating in the light guide plate 15, and the emitted light is used for displaying the image on the display surface 11DS of the liquid crystal panel 11. When the light propagating in the light guide plate 15 reaches one of the end surfaces 15a, 15d constituting the outer peripheral end surface of the light guide plate 15, there is a case where the light is emitted from the end surfaces 15a, 15d. The emitted light is reflected at the inner peripheral surface of the frame 18 surrounding the outer peripheral end surface of the light guide plate 15 and is incident on the end surfaces 15a, 15d of the light guide plate 15 again. An incidence angle of the re-incident light on the end surfaces 15a, 15d tends to be disordered with respect to the end surfaces 15a, 15d. Thus, when the light reaches the light exiting plate surface 15b after the light is re-incident, the incident angle with respect to the light exiting plate surface 15b exceeds a critical angle, so that the light is easy to emit from the light exiting plate surface 15b immediately. Therefore, as shown in FIG. 9, luminance distribution relating to the light emitted from the light exiting plate surface 15b is such that a quantity of the emitted light locally increases in an outer area closer to the end surfaces 15a and 15d in comparison to a quantity of emitted light in an inner area of the light exiting plate surface 15b. As a result, there is a risk that users visually recognize as luminance unevenness. FIG. 9 schematically illustrates the luminance distribution relating to the light emitted from the light exiting plate surface 15b of the light guide plate 15. A vertical axis in the figure indicates relative luminance of the emitted light and a horizontal axis indicates a position in the X axis direction or in the Y axis direction, respectively. With respect to the horizontal axis of FIG. 9, a Y1 end and a Y2 end shown in FIG. 5 and FIG. 6 and an X1 end and an X2 end shown in FIG. 5 and FIG. 7 are associated, respectively. Based on the above, in FIG. 9, luminance distribution (from the X1 end to the X2 end) in the X axis direction is shown using a solid line and luminance distribution (from the Y1 end to the Y2 end) in the Y axis direction is shown using a broken line, respectively.

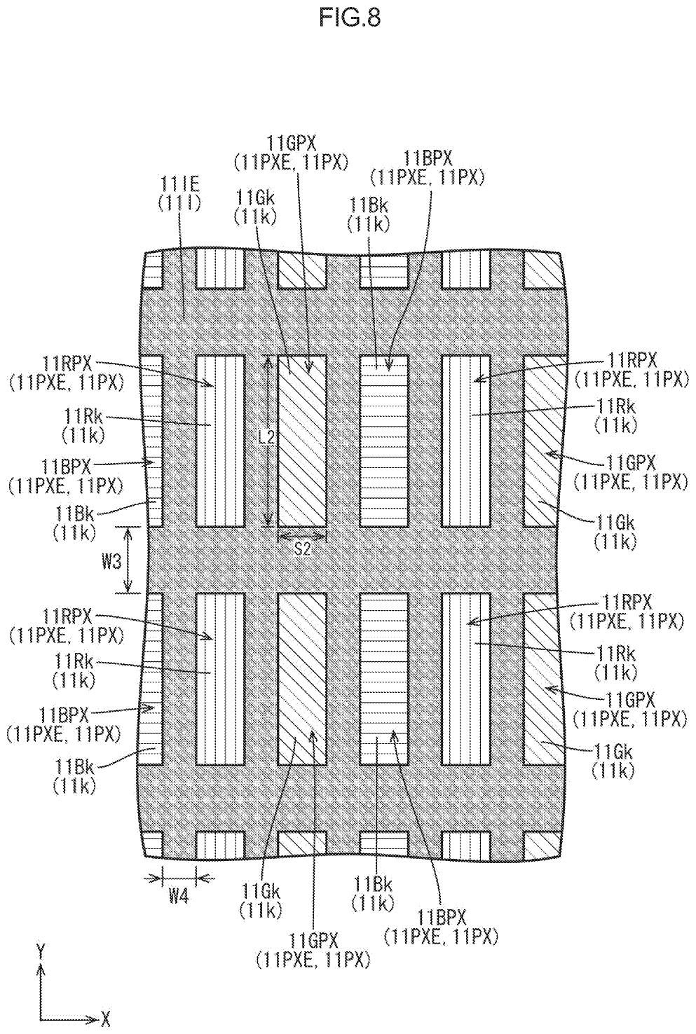

The liquid crystal panel 11 according to the present embodiment has the pixel portions 11PX as described above (see FIG. 3 and FIG. 4). The pixel portions 11PX include inner pixel portions 11PXC arranged in the inner area within the display surface 11DS and outer pixel portions 11PXE arranged in the outer area within the display surface 11DS as shown in FIG. 4 and FIG. 8. Light transmittance of each of the outer pixel portions 11PXE is lower than light transmittance of each of the inner pixel portions 11PXC. The “light transmittance” mentioned above is a ratio obtained by dividing a quantity of transmitted light of each of the pixel portions 11PXC, 11PXE by a quantity of incident light to each of the pixel portions 11PXC, 11PXE. In a case of distinguishing the pixel portions 11PX, a suffix C is added to the reference symbol of the “inner pixel portion” and a suffix E is added to the reference symbol of the “outer pixel portion”, and in a case of being collectively referred to without distinction, no suffix is added to the reference symbol. According to the above structure, even if the quantity of the light emitted from the light exiting plate surface 15b of the light guide plate 15 locally increases in the outer area, transmission of the light at each of the outer pixel portions 11PXE positioned in the outer area within the display surface 11DS of the liquid crystal panel 11 is suppressed more than that of each of the inner pixel portions 11PXC positioned in the inner area. Thus, difference of the quantity of the emitted light occurring between the inner area and the outer area of the display surface 11DS of the liquid crystal panel 11 is suppressed, so that occurrence of the luminance unevenness is suppressed. Since the occurrence of the luminance unevenness is suppressed by the outer pixel portions 11PXE of the liquid crystal panel 11, light reflectance of the frame 18 constituting the backlight device 12 need not be partially lowered as in a conventional case. Thereby, the light is efficiently reflected by the frame 18 and more light is returned to the light guide plate 15, so that light utilization efficiency becomes favorable. Since the frame 18 need not be manufactured by a two-color molding method as in the conventional case, a manufacturing cost is reduced. Thus, the occurrence of the luminance unevenness is suppressed while the favorable light utilization efficiency is maintained. The outer pixel portions 11PXE and the inner pixel portions 11PXC are arranged side by side along the X axis direction and the Y axis direction in the plane of the display surface 11DS.

In detail, as shown in FIG. 4 and FIG. 8, each of the outer pixel portions 11PXE has an opening area (an area of an opening) smaller than that of each of the inner pixel portions 11PXC. Specifically, a long side dimension L2 and a short side dimension S2 of each of the outer pixel portions 11PXE are smaller than a long side dimension L1 and a short side dimension S1 of each of the inner pixel portions 11PXC, respectively. An aperture ratio of the outer pixel portion 11PXE is lower than that of the inner pixel portion 11PXC, so that the light transmittance is relatively low. In order to make the opening areas (an aperture ratio) of the outer pixel portions 11PXE relatively small (low), sections (outer light shielding sections 11lE) of the light shielding portion 11l to partition the outer pixel portions 11PXE are wider than sections (inner light shielding sections 11lC) of the light shielding portion 11l to partition the inner pixel portions 11PXC. In a case of distinguishing the light shielding portion 11l, a suffix C is added to the reference symbol of the sections partitioning the inner pixel portions 11PXC as “inner light shielding sections”, and a suffix E is added to the reference symbol of the sections partitioning the outer pixel portions 11PXE as “outer light shielding sections”, and in a case of being collectively referred to without distinction, no suffix is added to the reference symbol. Specifically, a width dimension W3 of a section extending along the X axis direction and a width dimension W4 of a section extending along the Y axis direction of the outer light shielding section 11lE are set to be larger than a width dimension W1 of a section extending along the X axis direction and a width dimension W2 of a section extending along the Y axis direction of the inner light shielding section 11lC, respectively. Thus, inequalities of “W3>W1” and “W4>W2” hold. As described above, when the outer light shielding section 11lE is wider than the inner light shielding section 11lC, a light absorption amount by the outer light shielding section 11lE is larger than a light absorption amount by the inner light shielding section 11C. Thereby, the light transmittance in each of the outer pixel portions 11PXE is relatively low. The opening area of each of the pixel portions 11PXC, 11PXE is directly proportional to the light transmittance of each of the pixel portions 11PXC, 11PXE. On the other hand, the width dimension of each of the light shielding sections 11lC, 11lE that partitions each of the pixel portions 11PXC, 11PXE is inversely proportional to the light transmittance of each of the pixel portions 11PXC, 11PXE. The color filter 11k of each outer pixel portion 11PXE and the color filter 11k of each inner pixel portion 11PXC have the same coloring density. The pixel electrode 11g of each outer pixel portion 11PXE and the pixel electrode 11g of each inner pixel portion 11PXC have the same area.

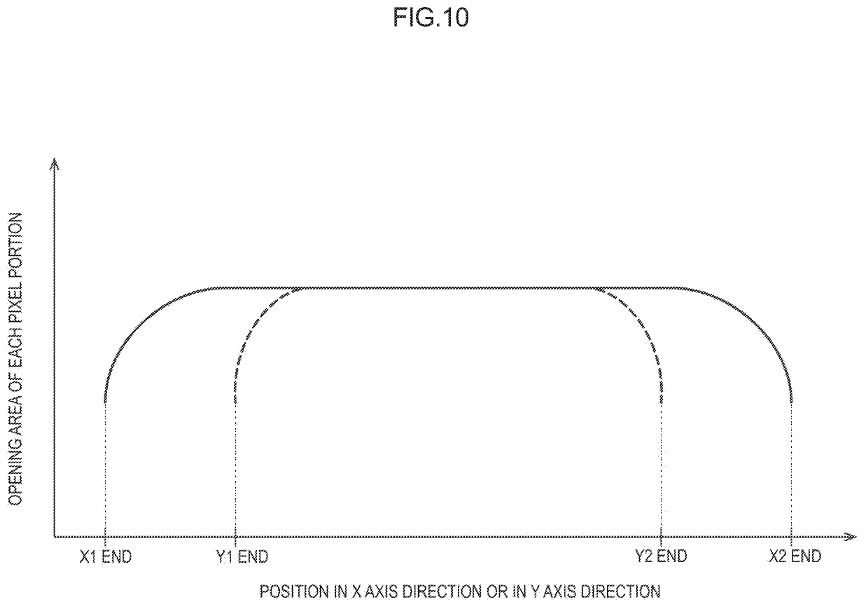

As shown in FIG. 8, the outer pixel portions 11PXE arranged along the X axis direction and the Y axis direction in the plane of the display surface 11DS of the liquid crystal panel 11 are disposed side by side at different positions of distance from the inner pixel portions 11PXC. As shown in FIG. 10, the opening area (light transmittance) of each of the outer pixel portions 11PXE is configured to become larger (higher) as approaching the inner from the outer in the plane of the display surface 11DS, conversely, to become smaller (lower) as approaching the outer from the inner. The opening area (light transmittance) of each of the outer pixel portions 11PXE is configured to gradually become larger (higher) as approaching the inner pixel portions 11PXC, conversely, to gradually become smaller (lower) as going away from the inner pixel portions 11PXC. FIG. 10 schematically illustrates distribution of the opening areas (aperture ratio) related to the pixel portions 11PX of the liquid crystal panel 11. A vertical axis in the figure indicates the opening area described above and a horizontal axis indicates position in the X axis direction or in the Y axis direction. With respect to the horizontal axis in FIG. 10, like FIG. 9, the Y1 end and the Y2 end shown in FIG. 5 and FIG. 6 and the X1 end and the X2 end shown in FIG. 5 and FIG. 7 are associated, respectively. Based on the above, in FIG. 10, the distribution of the opening areas (from the X1 end to the X2 end) in the X axis direction is shown using a solid line and the distribution of the opening areas (from the Y1 end to the Y2 end) in the Y axis direction is shown using a broken line, respectively. Curved portions in graphs of FIG. 10 correspond to an arrangement region of the outer pixel portions 11PXE (the outer light shielding section 11lE), and a linear portions of the graphs correspond to an arrangement region of the inner pixel portions 11PXC (the inner light shielding section 11lC). The opening area (light transmittance) of each of the outer pixel portions 11PXE changes such that a rate of change (gradient) becomes higher (steeper) as the outer, conversely, becomes lower (gentler) as the inner area (closer to the inner pixel portions 11PXC). The opening area (light transmittance) of each of the inner pixel portions 11PXC is substantially unchanged and constant.

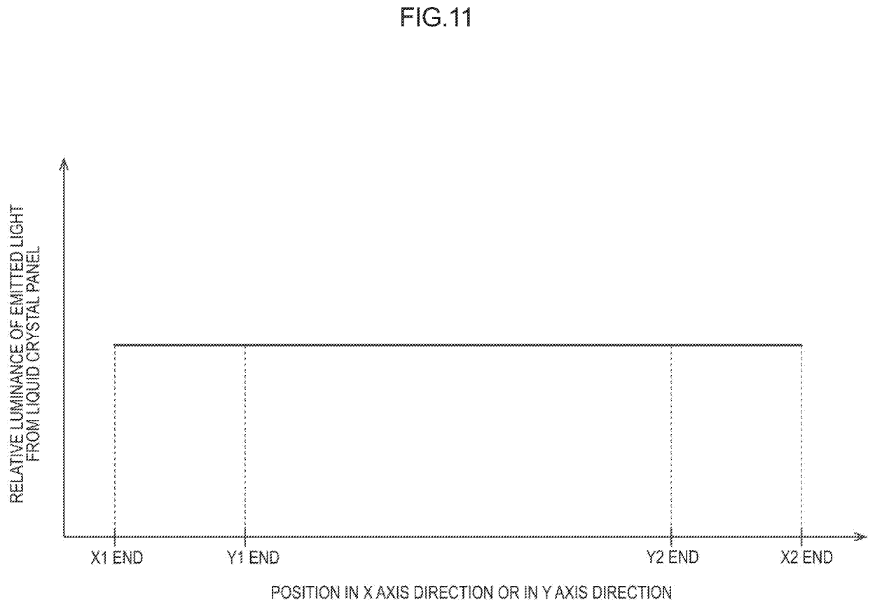

As shown in FIG. 9, the quantity of the light emitted from the light exiting plate surface 15b of the light guide plate 15 tends to decrease as approaching the inner area from the outer area. In contrast, as described above, the opening area (light transmittance) of each of the outer pixel portions 11PXE gradually becomes larger (higher) as approaching the inner pixel portions 11PXC, and the rate of change thereof becomes equal to a rate of change related to the quantity of the light emitted from the light exiting plate surface 15b. According to the above structure, as compared with a case where the opening areas (light transmittances) in the outer pixel portions are constant, difference between the quantity of the transmitted light of each of the outer pixel portions 11PXE closer to a center and the quantity of the transmitted light of each of the inner pixel portions 11PXC is less likely to occur. Specifically, as shown in FIG. 11, the luminance distribution relating to the light emitted from the display surface 11DS of the liquid crystal panel 11 is substantially uniform (flat) irrespective of the position in one of the X axis direction and the Y axis direction. FIG. 11 schematically illustrates the luminance distribution relating to the light emitted from the display surface 11DS of the liquid crystal panel 11. A vertical axis in the figure indicates relative luminance of the above emitted light and a horizontal axis indicates position in the X axis direction or in the Y axis direction. With respect to the horizontal axis of FIG. 11, like FIG. 9 and FIG. 10, the Y1 end and Y2 end shown in FIG. 5 and FIG. 6 and the X1 end and X2 end shown in FIG. 5 and FIG. 7 are associated, respectively. The above configuration makes it more difficult for the luminance unevenness to occur.

As described above, the liquid crystal display device (display device) 10 of the present embodiment includes the backlight device (lighting device) 12, the liquid crystal panel (display panel) 11 that displays the image on the display surface 11DS using the light from the backlight device 12. The backlight device 12 includes at least the LEDs (light source) 13, the light guide plate 15 having the light entering end surface 15a including at least a part of the outer peripheral end surface and on which the light from the LEDs 13 is incident and the light exiting plate surface 15b including one of the pair of plate surfaces and emits the light, and the frame (frame shaped reflection member) 18 formed into the frame shape surrounding the outer peripheral end surface of the light guide plate 15 and that reflects the light. The liquid crystal panel 11 includes the pixel portions 11PX each of which transmits the light from the backlight device 12. The light transmittance of each of the outer pixel portions 11PXE in the pixel portions 11PX arranged in the outer area of the display surface 11DS is lower than the light transmittance of each of the inner pixel portions 11PXC arranged at the inner with respect to the outer pixel portions 11PXE.

According to the above structure, when the light emitted from the LEDs 13 is incident on the light entering end surface 15a of the light guide plate 15, the light is emitted from the light exiting plate surface 15b after propagating in the light guide plate 15, and the emitted light is used for displaying the image on the display surface 11DS of the liquid crystal panel 11. When the light propagating in the light guide plate 15 reaches one of the end surfaces 15a, 15d constituting the outer peripheral end surface of the light guide plate 15, there is a case where the light is emitted from the end surfaces 15a, 15d. The emitted light is reflected by the frame 18 surrounding the outer peripheral end surface of the light guide plate 15 to be incident on the end surfaces 15a, 15d of the light guide plate 15 again. The incident angle of the re-incident light on the end surface 15a, 15d tends to be disordered with respect to the end surface 15a, 15d, so that the light is easily emitted from the light exiting plate surface 15b immediately. As a result, there is a risk that the quantity of the emitted light locally increases in the outer area of the light exiting plate surface 15b.

In that respect, the display panel 11 that displays the image on the display surface 11DS using the light from the backlight device 12 is configured that the light transmittance of each of the outer pixel portions 11PXE in the pixel portions 11PX arranged in the outer area of the display surface 11DS is lower than the light transmittance of each of the inner pixel portions 11PXC. Thus, even if the quantity of the emitted light from the light exiting plate surface 15b of the light guide plate 15 locally increases in the outer area, the light transmission at each of the outer pixel portions 11PXE is suppressed more than that of each of the inner pixel portions 11PXC, thereby the difference of the quantity of the emitted light generated between the inner area and the outer area of the display surface 11DS of the display panel 11 is reduced. As described above, since the occurrence of the luminance unevenness is suppressed by the outer pixel portions 11PXE of the display panel 11, the light reflectance of the frame 18 constituting the backlight device 12 need not be partially lowered as in the conventional case, so that light utilization efficiency becomes favorable. Since the frame 18 need not be manufactured by a two-color molding method as in the conventional case, a manufacturing cost is reduced. The above “light transmittance” is a ratio obtained by dividing a quantity of transmitted light by a quantity of incident light.

The area of each of the outer pixel portions 11PXE is smaller than that of each of the inner pixel portions 11PXC. Thereby, the light transmittance of each of the outer pixel portions 11PXE having the relatively small area is lower than that of each of the inner pixel portions 11PXC having a relatively large area.

The liquid crystal panel 11 includes the light shielding portion 11l that partitions the pixel portions 11PX. The light shielding portion 11l is formed such that the outer light shielding section 11lE that is the portion partitioning the outer pixel portions 11PXE is wider than the inner light shielding section 11lC that is the portion partitioning the inner pixel portions 11PXC. According to the above structure, the quantity of the light absorbed or reflected by the outer light shielding section 11lE in the light shielding portion 11l that is the portion partitioning the outer pixel portions 11PXE becomes larger than the quantity of the light absorbed or reflected by the inner light shielding section 11lC in the light shielding portion 11l that is the portion partitioning the inner pixel portions 11PXC, so that the light transmittance of each of the outer pixel portions 11PXE becomes relatively low.

In addition, the outer pixel portions 11PXE are arranged side by side at the different positions of the distance from the inner pixel portions 11PXC and the light transmittance of each of the outer pixel portions 11PXE gradually becomes higher as approaching the inner pixel portions 11PXC. The quantity of the light emitted from the light exiting plate surface 15b of the light guide plate 15 tends to decrease as approaching the inner area from the outer area. In contrast, as described above, since the light transmittance of each of the outer pixel portions 11PXE gradually becomes higher as approaching the inner pixel portions 11PXC, the difference between the quantity of the transmitted light of each of the outer pixel portions 11PXE closer to the center and the quantity of the transmitted light of each of the inner pixel portions 11PXC is less likely to occur, as compared with the case where the light transmittances of the outer pixel portions are constant. The above configuration makes it more difficult for the luminance unevenness to occur.

The light reflectance of the frame 18 is larger than the numerical value obtained by adding the light absorption rate and the light transmittance. Thereby, when the light emitted from the end surfaces 15a, 15d of the light guide plate 15 hits the frame 18, the quantity of the light reflected by the frame 18 is larger than the quantity of the light absorbed by the frame 18 or the quantity of the light transmitted through the frame 18. The light reflected by the frame 18 is incident on the end surface 15a, 15d of the light guide plate 15 again and then emitted from the light exiting plate surface 15b, so that the emitted light is effectively utilized for displaying the image on the liquid crystal panel 11. As a result, the light utilization efficiency becomes favorable.

### Second Embodiment

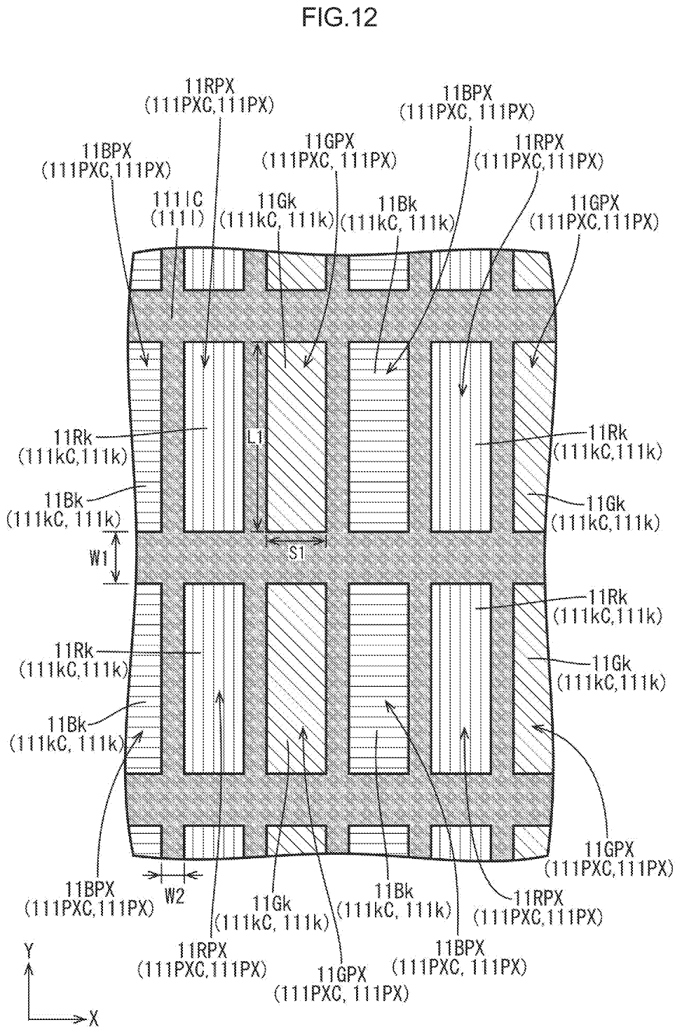

A second embodiment of the present invention will be described with reference to FIG. 12 to FIG. 15. In the second embodiment, a configuration of pixel portions 111PX that are changed will be described. Duplicate descriptions of the same structure, operation and effect as those of the first embodiment described above will be omitted.

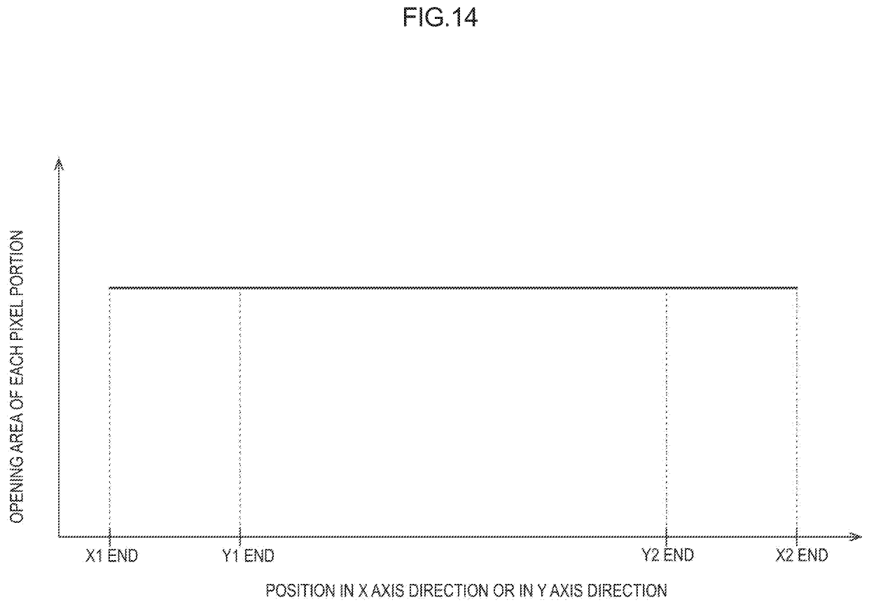

As shown in FIG. 12 to FIG. 14, pixel portions 111PX according to the present embodiment are configured that an opening area of each of outer pixel portions 111PXE is substantially equal to an opening area of each of inner pixel portions 111PXC. Specifically, long side dimensions L1 of each of the outer pixel portions 111PXE and each of the inner pixel portions 111PXC are equal to each other, and short side dimensions S1 of each of the outer pixel portions 111PXE and each of the inner pixel portions 111PXC are equal to each other. Thus, width dimensions W1 of an outer light shielding section 111lE and an inner light shielding section 111lC constituting a light shielding portion 111l are equal to each other, and width dimensions W2 of the outer light shielding section 111lE and the inner light shielding section 111lC are equal to each other. As describe above, the opening areas of the pixel portions 111PX are substantially constant over an entire area in a plane of the display surface of the liquid crystal panel. FIG. 14 schematically illustrates distribution of the opening areas relating to the pixel portions 111PX of the liquid crystal panel. A vertical axis in the figure indicates the aperture ratio described above, a horizontal axis indicates position in the X axis direction or in the Y axis direction. With respect to the horizontal axis of FIG. 14, like FIG. 9 to FIG. 11 described in the first embodiment, the Y1 end and the Y2 end shown in FIG. 5 and FIG. 6 and the X1 end and the X2 end shown in FIG. 5 and FIG. 7 are associated respectively.

Meanwhile, light absorption rate of each of the outer pixel portions 111PXE included in the pixel portions 111PX is higher than that of each of the inner pixel portions 111PXC. The “light absorption rate” referred to here is a ratio obtained by dividing a quantity of the light absorbed by each of the pixel portions 111PXC, 111PXE by a quantity of the incident light on each of the pixel portions 111PXC, 111PXE. The quantity of the light absorbed by each of the pixel portions 111PXC, 111PXE is obtained by subtracting the quantity of the transmitted light and a quantity of the reflected light from the quantity of the incident light. The outer pixel portion 111PXE having the relatively high light absorption rate tends to have the smaller quantity of the transmitted light as compared with the inner pixel portion 111PXC having the relatively lower light absorption rate because the outer pixel portion 111PXE absorbs more incident light. As a result, the light transmittance of the outer pixel portion 111PXE becomes relatively low. Thus, like the first embodiment described above, the occurrence of the luminance unevenness is suppressed while favorable light utilization efficiency is maintained.

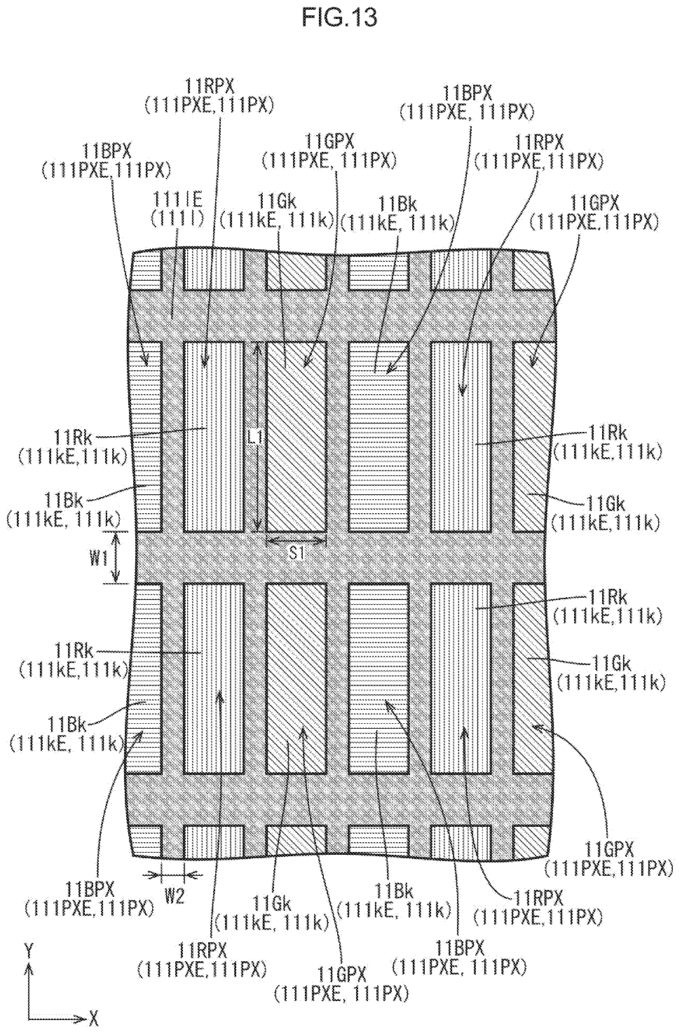

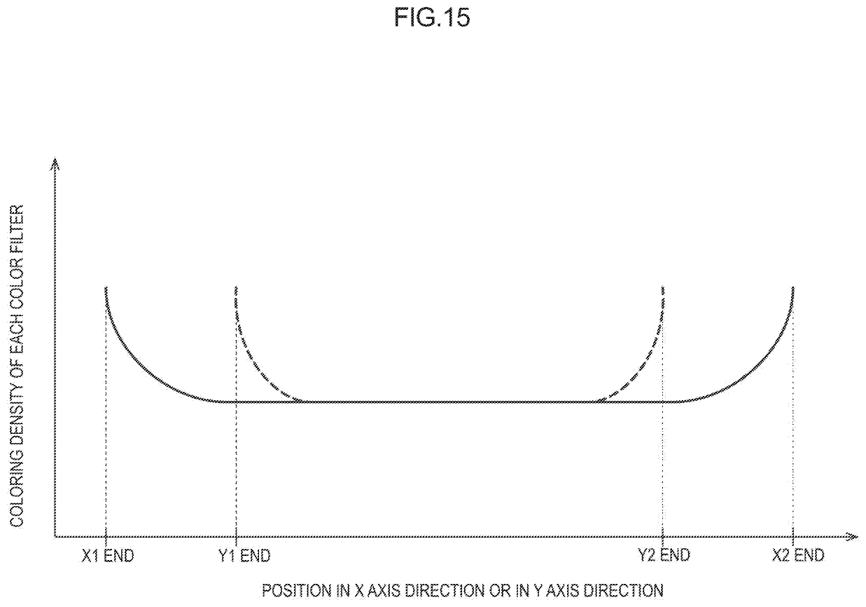

Specifically, as shown in FIG. 12, FIG. 13 and FIG. 15, coloring density of an outer color filter 111kE constituting the outer pixel portion 111PXE is higher than that of an inner color filter 111kC constituting the inner pixel portion 111PXC. The “coloring density” refers to a concentration of pigment contained in a color filter 111k. As the concentration of the pigment increases, the pigment absorbs a large quantity of non-colored light to increase the light absorption rate. Conversely, as the concentration of the pigment decreases, the quantity of the non-colored light absorbed by the pigment decreases and the light absorption rate tends to decrease. Thus, the coloring densities of the color filters 111kC, 111kE in the respective pixel portions 111PXC, 111PXE are directly proportional to the light absorption rate of the respective pixel portions 111PXC, 111PXE, and are inversely proportional to the light transmittance of the respective pixel portions 111PXC, 111PXE. In FIG. 12 and FIG. 13, the closer an interval of a hatching drawn on each of the color filters 111kC, 111kE is, the higher the coloring density becomes, and conversely, the wider the interval of the hatching is, the lower the coloring density becomes. In a case of distinguishing the color filters 111k, the suffix C is added to the reference symbol of the “inner color filter” and the suffix E is added to the reference symbol of the “outer color filter”, and in a case of being collectively referred to without distinction, no suffix is added to the reference symbol. FIG. 15 schematically illustrates the distribution of the coloring densities relating to the color filters 111k. A vertical axis in the figure indicates the coloring density described above and a horizontal axis indicates position in the X axis direction or in the Y axis direction. With respect to the horizontal axis in FIG. 15, like FIG. 14, the Y1 end and the Y2 end shown in FIG. 5 and FIG. 6 and the X1 end and the X2 end shown in FIG. 5 and FIG. 7 are associated, respectively. Based on the above, in FIG. 15, the distribution of the coloring densities (from the X1 end to the X2 end) in the X axis direction is shown using a solid line and the distribution of the coloring densities (from the Y1 end to the Y2 end) in the Y axis direction is shown using a broken line. Curved portions in graphs of FIG. 15 correspond to an arrangement region of the outer pixel portions 111PXE (the outer color filters 111kE), and linear portions of the graphs correspond to an arrangement region of the inner pixel portions 111PXC (the inner color filters 111kC). The coloring density (light transmittance) of each of the outer color filters 111kE changes such that a rate of change (gradient) becomes higher (steeper) in the outer area. Conversely, the rage of change becomes lower (gentler) in the inner area (closer to the inner pixel portions 111PXC). Meanwhile, the coloring density (light transmittance) of each of the inner color filters 111kC is substantially unchanged and constant. Like the first embodiment, the coloring density (light transmittance) of each of the color filters 111kC, 111kE of the outer pixel portions 111PXE gradually becomes lower (higher) as approaching the inner pixel portions 111PXC, and the rate of change of the coloring density becomes equal to a rate of change (see FIG. 9) related to the quantity of the light emitted from the light exiting plate surface of the light guide plate.

As described above, according to the present embodiment, each of the outer pixel portions 111PXE has the higher light absorption rate than that of each of the inner pixel portions 111PXC. According to the structure, the light transmittance of each of the outer pixel portions 111PXE having the relatively high light absorption rate is lower than that of each of the inner pixel portions 111PXC having the relatively low light absorption rate.

The liquid crystal panel includes at least the color filters (coloring portions) 11k constituting the pixel portions 111PX and selectively transmitting the light of a specific color, the inner color filters (inner coloring portions) 111kC included in the color filters 111k and constituting the inner pixel portions 111PXC, and the outer color filters (outer coloring portions) 111kE included in the color filters 111k to constitute the outer pixel portions 111PXE and having the higher coloring density than that of each of the inner color filters 111kC. Each of the color filters 11k constituting the pixel portion 111PX absorbs the light so as to selectively transmit the light of the specific color. Each of the outer color filters 111kE constituting the outer pixel portion 111PXE in the color filters 111k has the higher coloring density than that of each of the inner color filters 111kC constituting the inner pixel portion 111PXC, thereby, the outer color filter 111kE absorbs a relatively large quantity of the light. Thus, the light transmittance of each of the outer pixel portions 111PXE becomes relatively low.

### Other Embodiments

The present invention is not limited to the embodiments described by the above description and drawings, and the following embodiments are also included in the technical scope of the present invention.

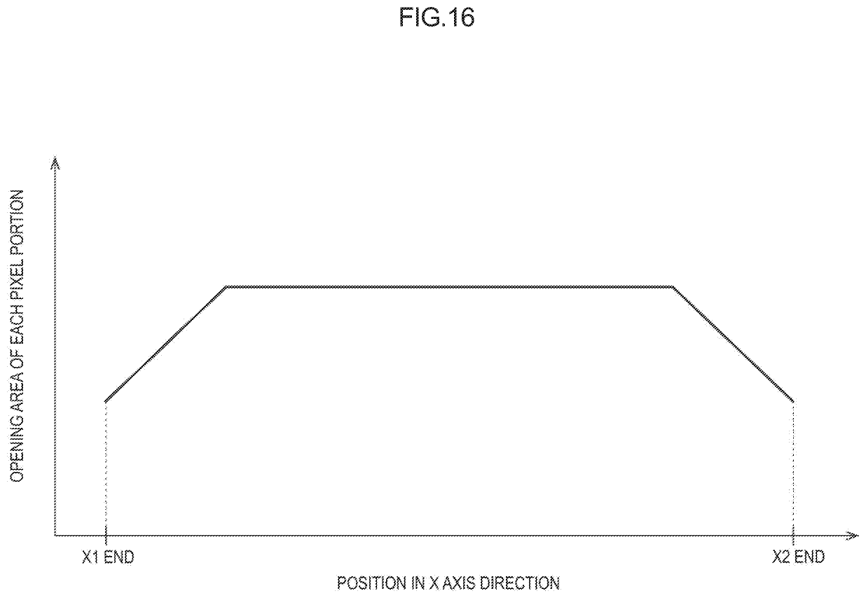

(1) As a modification of the first embodiment, as shown in FIG. 16, a configuration in which the opening area of each of the outer pixel portions changes in an inclined manner, that is, a configuration in which the rate of change in the opening areas of the outer pixel portions is constant is allowed. In FIG. 16, although the distribution of the opening area of each of the pixel portions in the X axis direction in the liquid crystal panel is illustrated as a representative, the distribution of the opening area of each of the pixel portions in the Y axis direction in the liquid crystal panel is also the same.

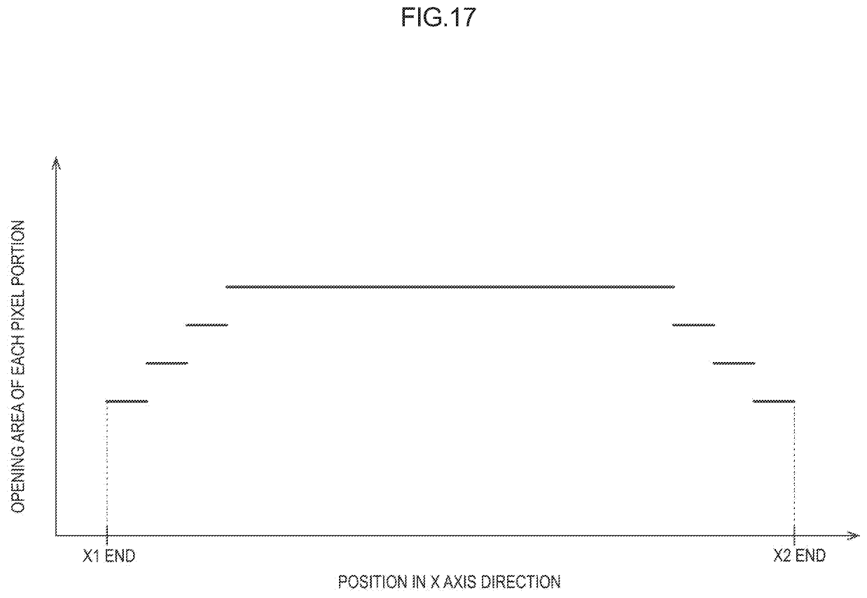

(2) As a modification of the first embodiment, as shown in FIG. 17, a configuration in which the opening area of each of the outer pixel portions sequentially changes step by step with the stages (three stages in FIG. 17) is allowed. In FIG. 17, although the distribution of the opening area of each of the pixel portions in the X axis direction in the liquid crystal panel is illustrated as a representative, the distribution of the opening area of each of the pixel portions in the Y axis direction in the liquid crystal panel is the same. In addition to the configuration shown in FIG. 17, the number of the stages may be appropriately changed.

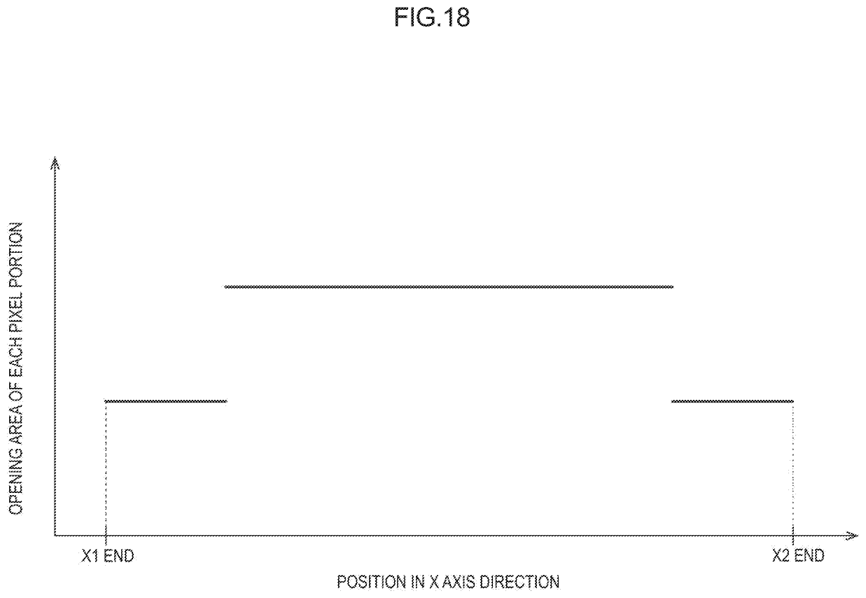

(3) As a modification of the first embodiment, as shown in FIG. 18, the opening areas of the outer pixel portions may be constant. In FIG. 18, although the distribution of the opening area of each of the pixel portions in the X axis direction in the liquid crystal panel is illustrated as a representative, the distribution of the opening area of each of the pixel portions in the Y axis direction in the liquid crystal panel is the same.

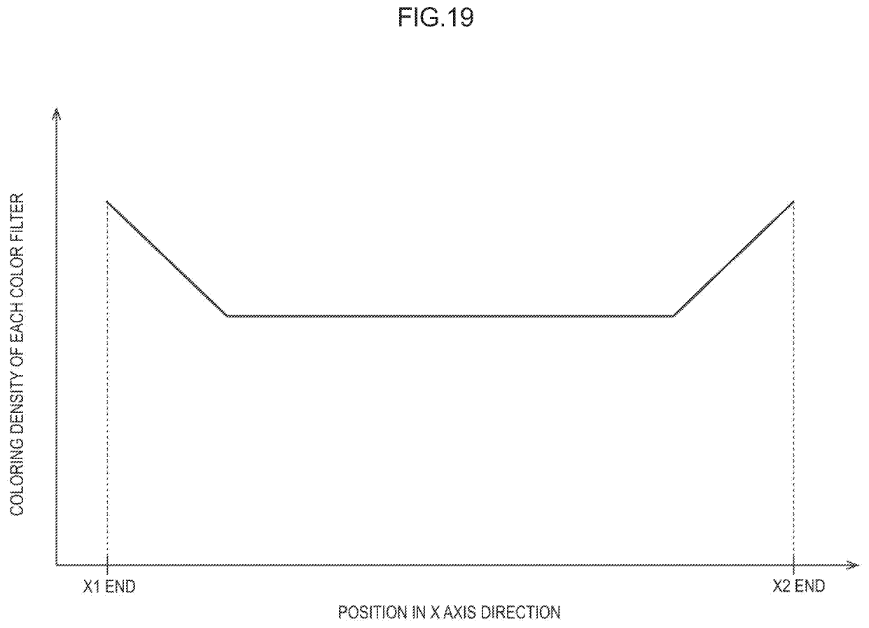

(4) As a modification of the second embodiment, as shown in FIG. 19, a configuration in which the coloring density of each of the outer color filters constituting the outer pixel portions changes in an inclined manner, that is, a configuration in which the rate of change in the coloring densities of the outer color filters is constant is allowed. In FIG. 19, although the distribution of the coloring density of each of the color filters of the pixel portions in the X axis direction in the liquid crystal panel is illustrated as a representative, the distribution of the coloring density of each of the color filters of the pixel portions in the Y axis direction in the liquid crystal panel is the same.

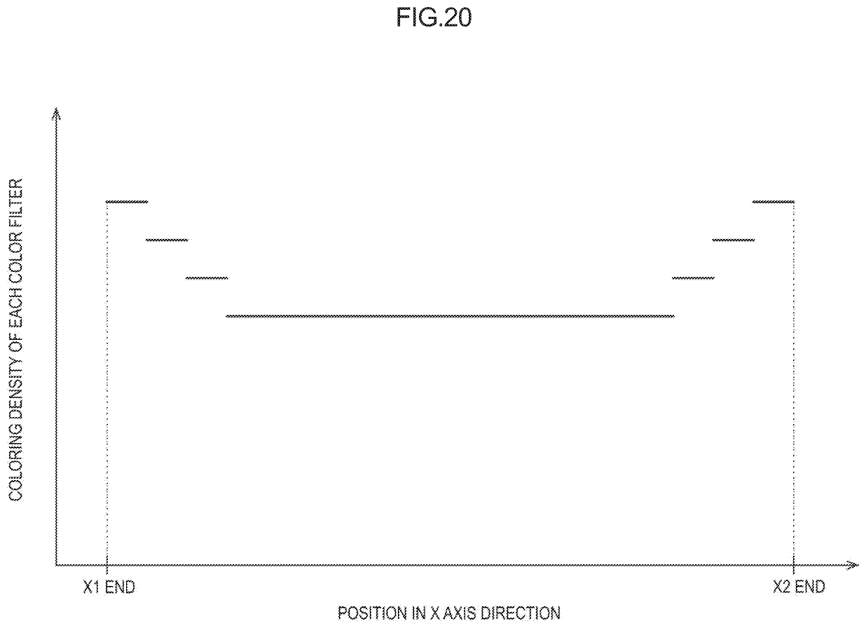

(5) As a modification of the second embodiment, as shown in FIG. 20, a configuration in which the coloring density of each of the outer color filters constituting the outer pixel portions is sequentially changed step by step with the stages (three stages in FIG. 20) is allowed. In FIG. 20, although the distribution of the coloring density of each of the color filters of the pixel portions in the X axis direction in the liquid crystal panel is illustrated as a representative, the distribution of the coloring density of each of the color filters of the pixel portions in the Y axis direction in the liquid crystal panel is the same. In addition to the configuration shown in FIG. 20, the number of the stages may be appropriately changed.

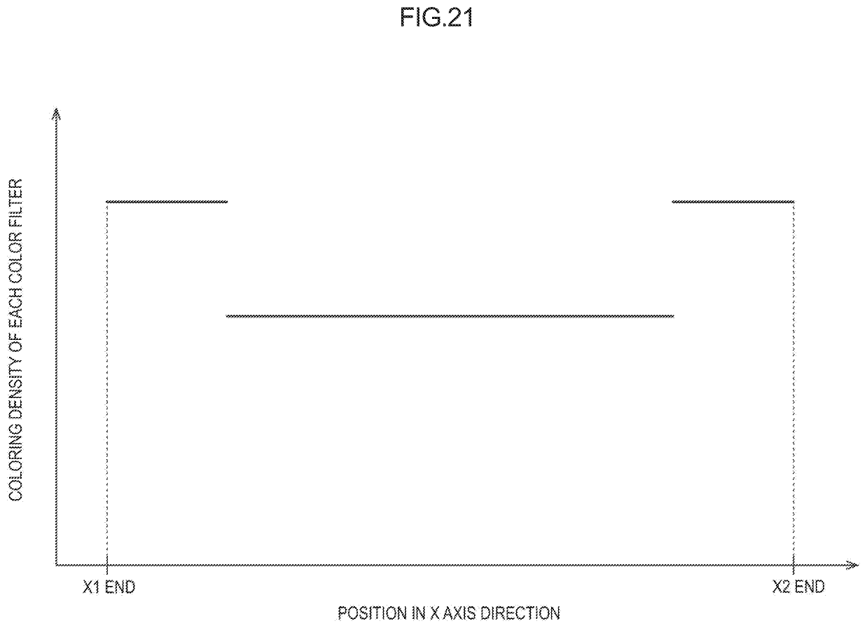

(6) As a modification of the first embodiment, as shown in FIG. 21, the coloring densities of the outer color filters constituting the outer pixel portions may be constant. In FIG. 21, although the distribution of the coloring density of each of the color filters of the pixel portions in the X axis direction in the liquid crystal panel is illustrated as a representative, the distribution of the coloring density of each of the color filters of the pixel portions in the Y axis direction in the liquid crystal panel is the same.

(7) In addition to the above embodiments including (1) to (6), the specific distributions (how to change and the rate of change) of the opening area relating to each of the pixel portions and the coloring density of each of the color filters may be appropriately changed. For example, in a case in which the luminance distribution relating to the light emitted from the light guide plate constituting the backlight device is an asymmetric distribution, the distributions of the opening area relating to each of the pixel portions and the coloring density of each of the color filters may be asymmetric.

(8) By combining the first and the second embodiments to make the opening areas of the pixel portions different from each other and make the coloring densities of the color filters constituting the pixel portions different each other, the light transmittance of each of the outer pixel portions may become lower than that of each of the inner pixel portions.

(9) In the first embodiment, the case in which the long side dimension and the short side dimension of each of the outer pixel portions are smaller than the long side dimension and the short side dimension of each of the inner pixel portions, respectively is shown. A configuration in which one of the long side dimension and the short side dimension of each of the outer pixel portions is the same as that of each of the inner pixel portions and the other of the long side dimension and the short side dimension of each of the outer pixel portions is smaller than that of each of the inner pixel portions is allowed.

(10) In the first embodiment, the case where the opening area of each of the outer pixel portions is made smaller than that of each of the inner pixel portions by widening the outer light shielding sections partitioning the outer pixel portions is shown. In addition to this structure, for example, a light shielding structure may be newly provided separately from the light shielding section, or an area of an existing light shielding structure (gate line, source line, TFT, photo spacer, or the like) other than the light shielding section may be expanded, and the opening area of each of the outer pixel portions may be smaller than that of each of the inner pixel portions.

(11) In the second embodiment, the case in which the light absorption rate of each of the outer pixel portions is made higher than that of each of the inner pixel portions by making the coloring density of each of the outer color filters constituting the outer pixel portions relatively high is shown. In addition to this structure, for example, by including a material (light absorbing material) that absorbs the light other than the pigment in each of the outer color filters constituting the outer pixel portions, the light absorption rate of each of the outer pixel portions may be made higher than that of each of the inner pixel portions.

(12) In each of the above described embodiments, the case in which the schematic luminance distribution related to the emitted light from the light guide plate constituting the backlight device has substantially constant luminance on the inner and relatively high luminance in the outer area is exemplified. When a configuration of the backlight device is changed, naturally, the luminance distribution relating to the emitted light from the light guide plate may also change accordingly. In that case, the opening area of each of the outer pixel portions and the distribution of the coloring densities of the outer color filters constituting the outer pixel portions may be appropriately changed in accordance with the luminance distribution relating to the emitted light from the light guide plate.

(13) In each of the above embodiments, the case in which each of the color filters contains the pigment is shown. A configuration in which each of the color filters contains dye is allowed.

(14) In each of the above embodiments, the case where the light reflectance of the frame is 90% or more is exemplified. The specific numerical value of the light reflectance of the frame may be changed, and it may be lower than 90%. The color of the surface of the frame may be appropriately changed in addition to white.

(15) In each of the above embodiments, the case where the light absorption rate of the light shielding portion in the liquid crystal panel is 90% or more is exemplified. The specific numerical value of the light absorption rate of the light shielding portion may be changed, and it may be lower than 90%. The color of the surface of the light shielding portion may be appropriately changed in addition to black.

(16) In each of the above embodiments, the case where the planar shape of the liquid crystal display device (liquid crystal panel or backlight device) is a horizontally elongated rectangle is shown. The planar shape of the liquid crystal display device may be a vertically elongated rectangle, a square, an elliptical shape, an oval shape, a circular shape, a trapezoidal shape, or the like.

(17) In each of the above embodiments, the liquid crystal panel in which the operation mode is set to the FFS mode is exemplified. In addition to this configuration, other operation modes such an in-plane switching (IPS) mode or a vertical alignment (VA) mode may be applied to the liquid crystal panel.

(18) In each of the above embodiments, the one side light incident type backlight device in which the end surface on the one long side in the outer peripheral end surface of the light guide plate is set as the light entering end surface is exemplified. The one side light incident type backlight device in which the end surface on one of short sides in the outer peripheral end surface of the light guide plate is set as the light entering end surface is allowed. A double side light incident type backlight device in which each of the end surfaces on a pair of the long sides or each of the end surfaces on a pair of the short sides in the outer peripheral end surface of the light guide plate serves as the light entering end surface is also allowed. In addition, a three side light incident type backlight device in which each of arbitrary three end surfaces in the outer peripheral end surface of the light guide plate serves as the light entering end surface and a four side light incident type backlight device in which all the outer peripheral end surface of the light guide plate serves as the light entering end surfaces are allowed.

(19) In addition to the above embodiments, the specific number, type, lamination order, and the like of the optical sheets used for the backlight device may be appropriately changed.

(20) In addition to the above embodiments, the reflection sheet covering the emitting opposite plate surface of the light guide plate may be omitted.

(21) In addition to the above embodiments, the number of the mounted LEDs on the LED substrate may be appropriately changed. Also, the number of the LED substrates used may be also appropriately changed.

(22) Although, in each of the above embodiments, the side surface emission type LEDs are shown, also top surface emission type LEDs may be used as the light source. Also light sources other than LEDs (organic electro luminescence (EL) or the like) may be used.

(23) In each of the above embodiments, the color filters of the liquid crystal panel including three colors of the red, the green, and the blue are exemplified. The present invention is applicable to also a configuration having color filters of four color composition in which yellow or white is added to the red, the green, and the blue.

(24) In each of the above embodiments, the liquid crystal panel having a configuration in which the liquid crystal layer is sandwiched between the pair of substrates is exemplified. The present invention is applicable to also a display panel in which a functional organic molecule (medium layer) other than a liquid crystal material is sandwiched between the pair of substrates.

(25) In each of the above embodiments, the TFT is used as the switching element of the liquid crystal panel. The present invention is applicable to also a liquid crystal panel using a switching element other than the TFT (for example, a thin film diode (TFD)), and applicable to also a liquid crystal panel displaying black and white in addition to the liquid crystal panel displaying color.

(26) In each of the above embodiments, the liquid crystal panel is exemplified as the display panel. The present invention is applicable to also other types of display panels (a plasma display panel (PDP), an organic EL panel, an electrophoretic display panel (EPD), a micro electro mechanical systems (MEMS) display panel, or the like).

### EXPLANATION OF SYMBOLS

10: Liquid crystal display device (Display device)
11: Liquid crystal panel (Display panel)
11k, 111k: Color filter (Coloring portion)
11l, 111l: Light shielding portion
11lC, 111lC: Inner side light shielding section (section that partitions the inner pixel portions)
11lE, 111lE: Outer light shielding section (section that partitions the outer pixel portions)
11DS: Display surface
11PX, 111PX: Pixel portion
11PXC, 111PXC: Inner pixel portion
11PXE, 111PXE: Outer pixel portion
12: Backlight device (Lighting device)
13: LED (Light source)
15: Light guide plate
15a: Light entering end surface (Outer peripheral end surface)
15b: Light exiting plate surface
15d: Non-light entering end surface (Outer peripheral end surface)
18: Frame (Frame shaped reflection member)
111kC: Inner color filter (inner coloring portion)
111kE: Outer color filter (outer coloring portion)

1. A display device comprising:
a lighting device; and
a display panel that displays an image on a display surface using light from the lighting device, wherein
the lighting device includes:
a light source;
a light guide plate including a light entering end surface that includes at least a part of an outer peripheral end surface and through which light from the light source enters and a light exiting plate surface including one of plate surfaces through which the light exits; and
a frame shaped reflection member having a frame shape and surrounding the outer peripheral end surface of the light guide plate, the frame shaped reflection member reflecting the light,
the display panel includes a plurality of pixel portions each of which transmits the light from the lighting device,
the plurality of pixel portions include outer pixel portions arranged in an outer area of the display surface and inner pixel portions arranged in an inner area of the display surface inner than the outer pixel portions, and
the outer pixel portions have light transmittance lower than light transmittance of the inner pixel portions.

2. The display device according to claim 1, wherein each of the outer pixel portions has an area smaller than an area of each of the inner pixel portions.

3. The display device according to claim 2, wherein
the display panel includes a light shielding portion that partitions the plurality of pixel portions, and
the light shielding portion includes sections that partition the outer pixel portions and sections that partition the inner pixel portions, the sections that partition the outer pixel portions being wider than the sections that partition the inner pixel portions.

4. The display device according to claim 1, wherein each of the outer pixel portions has a light absorption rate higher than a light absorption rate of each of the inner pixel portions.

5. The display device according to claim 4, wherein
the display panel includes a plurality of coloring portions included in the plurality of pixel portions and transmitting specific colors of light rays, and
the plurality of coloring portions include: inner coloring portions included in the inner pixel portions; and outer coloring portions included in the outer pixel portions and having coloring densities higher than coloring densities of the inner coloring portions.

6. The display device according to claim 1, wherein the outer pixel portions are arranged at positions that are at different distances from the inner pixel portions and the light transmittance of the outer pixel portions gradually becomes higher as approaching the inner pixel portions.

7. The display device according to claim 1, wherein the frame shaped reflection member has a light reflectance greater than a sum of a light absorption rate and light transmittance.
